(19) United States
(12) Patent Application Publication
(10) Pub. No.: US 2014/0083459 A1
(43) Pub. Date: Mar. 27, 2014

(54) SYSTEMS AND METHODS RELATED TO CLEANING DURING MANUFACTURE OF RADIO-FREQUENCY MODULES

(71) Applicant: SKYWORKS SOLUTIONS, INC., Woburn, MA (US)

(72) Inventors: Matthew Sean READ, Rancho Santa Margarita, CA (US); Hoang Mong NGUYEN, Fountain Valley, CA (US); Sergio Joaquin GONZALEZ, Mexicali (MX); Luis Eduardo HERRERA, Mexicali (MX); Heliodoro OSUNA, Mexicali (MX)

(21) Appl. No.: 14/020,799

(22) Filed: Sep. 7, 2013

Related U.S. Application Data
(60) Provisional application No. 61/698,620, filed on Sep. 8, 2012.
(60) Provisional application No. 61/698,621, filed on Sep. 8, 2012.

(51) Int. Cl. B65G 15/54; B08B 3/02

(52) U.S. Cl. CPC B65G 15/54; B08B 3/022
USPC 134/15; 134/122 R; 134/64 R; 198/848

(57) ABSTRACT

Disclosed are systems and methods related to cleaning during manufacture of radio-frequency (RF) modules. Such modules can be manufactured in an array on a panel. At one or more stages, it can be desirable to perform cleaning operations for such panels. In some embodiments, a cleaning system can include a first belt transport apparatus configured to support a first surface of the panel and move the panel during a cleaning process. The cleaning system can further include a second belt transport apparatus configured to engage a second surface of the panel to keep the panel on the first belt transport apparatus during the cleaning process. At least the second belt transport apparatus can include a mesh, with the mesh having a coating configured to reduce the likelihood of damage to the second surface of the panel and to provide desired electrostatic discharge protection for the panel.

### CROSS-REFERENCE TO RELATED APPLICATIONS

This application claims priority to U.S. Provisional Application Nos. 61/698,620 filed Sep. 8, 2012 and entitled “CLEANING BELT HAVING CONDUCTIVE REDUCED-FRICTION COATING,” and 61/698,621 filed Sep. 8, 2012 and entitled “ABLATION SYSTEMS AND METHODS FOR SHIELDING APPLICATION,” each of which is expressly incorporated by reference herein in its entirety.

### BACKGROUND

1. Field

The present disclosure generally relates to removal of overmold material from a panel having an array of radio-frequency modules, and cleaning of the panel.

2. Description of the Related Art

In some applications involving packaging of radio-frequency (RF) modules, an array of such modules can be fabricated in an array on a panel. An overmold structure can be formed on the panel to encapsulate various components of the modules.

In some situations, it can be desirable to remove a portion of such an overmold. Upon such removal, or during some other manufacturing process, it can also be desirable to clean the panel.

### SUMMARY

According to a number of implementations, the present disclosure relates to a system for ablating a panel having electronic modules formed thereon. The system includes a blasting apparatus configured to provide a stream of particles to a blasting region. The system further includes a first transport section configured to move the panel through the blasting region and receive the stream of particles to thereby allow removal of a surface of the panel. The system further includes a second transport section configured to move the panel to or from the first transport section such that the second transport section is substantially isolated from the stream of particles.

In some embodiments, the second transport section can be a loading transport section that moves the panel to the first transport section. In some embodiments, the system can further include a third transport section configured to unload the panel from the first transport section such that the third transport section is substantially isolated from the stream of particles. Each of the first, second and third transport sections can include a conveyor belt driven by one or more pulleys. The conveyor belt for the first transport section can be configured to withstand repeated exposure to the stream of particles. The conveyor belt for the first transport section can be perforated with a plurality of openings, with the openings being dimensioned to allow the conveyor belt to support the panel and to allow at least some of the particles sprayed in the blasting region to fall through. The conveyor belt for the first transport section can be sufficiently conductive to provide a desired electrostatic discharge (ESD) protection property. The conveyor belt for the first transport section can be configured to be resiliently soft to absorb impact energy of the stream of particles without having parts of the conveyor belt ablated off.

In some embodiments, the system can further include at least one tracking sensor for each of the first, second, and third transport sections, with the tracking sensor being configured to facilitate tracking movement of the panel. The system can further include an input assembly configured to allow automated feeding of a plurality of panels in series to the loading transport section. The input assembly can include a magazine configured to hold the plurality of panels. The system can further include an output assembly configured to allow automated receiving of a plurality of panels in series from the unloading transport section. The output assembly can include a magazine configured to hold the plurality of panels.

In some embodiments, each of the first, second, and third transport sections can be provided with an input tracking sensor and an output tracking sensor configured to detect entry and exit of the panel into and out of the respective transport section. The first transport section can be further provided with an activation sensor configured to activate or deactivate operation of the blasting apparatus.

In some embodiments, the system can further include a controller configured to control operation of the system based at least in part on signals from the tracking sensors.

In some implementations, the present disclosure relates to a method for ablating a panel having electronic modules formed thereon. The method includes transporting the panel through an input section and transporting the panel received from the input section through a blasting section that includes a blasting region where a stream of particles is provided to yield an ablated panel. The method further includes transporting the ablated panel received from the blasting section through an output section. Each of the input section and the output section is substantially isolated from the stream of particles.

In some embodiments, the transporting of the panel through the input section, the transporting of the panel through the blast section, and the transporting of the panel through the output section can be controlled by a processor. In some embodiments, the ablation method can be performed automatically for a plurality of panels.

According to some teachings, the present disclosure relates to a device for transporting a panel having electronic modules formed thereon during a cleaning process. The device includes a mesh configured to engage a surface of the panel during the cleaning process. The mesh includes a coating configured to reduce the likelihood of damage to the surface of the panel and to provide desired electrostatic discharge protection for the panel.

In some embodiments, the coating of the mesh can be configured to provide a desired mechanical property and a desired electrical conductivity. The mechanical property of the coating of the mesh can include either or both of smoothness and softness. The coated mesh can have an edge-to-edge resistance R that is within a range of 1×10⁴≦R≦1×10¹¹ ohms when measured on the coating. The coated mesh can have a resistivity value associated with a conductive electrostatic discharge protective device. The coated mesh can have a resistivity value associated with a dissipative electrostatic discharge protective device.

In some embodiments, the coating can include fluoropolymer with small conductive particles mixed in. Such a coating can facilitate desired functionality of the mesh in an example application where the surface of the panel includes an ablated surface of the panel, with the ablated surface having exposed wires of shielding wirebonds, such that the desired mechanical property of the coating reduces or eliminates the likelihood of damage to the exposed wires.

In accordance with a number of implementations, the present disclosure relates to a system for cleaning a panel having electronic modules formed thereon. The system includes a first belt transport apparatus configured to support a first surface of the panel and move the panel during a cleaning process. The system further includes a second belt transport apparatus configured to engage a second surface of the panel to keep the panel on the first belt transport apparatus during the cleaning process. The second belt transport apparatus includes a mesh, with the mesh having a coating configured to reduce the likelihood of damage to the second surface of the panel and to provide desired electrostatic discharge protection for the panel.

In some embodiments, the first belt transport apparatus can include an uncoated metal mesh. The coating of the mesh of the second belt transport apparatus can include fluoropolymer with small conductive particles mixed in. The second surface of the panel can include an ablated surface of the panel, with the ablated surface having exposed wires of shielding wirebonds, such that the coating of the mesh reduces or eliminates the likelihood of damage to the exposed wires.

In some embodiments, the panel can be oriented so that the first surface faces downwards and the second surface faces upwards. The system can further include a wash section, a rinse section, and a dry section. Each of the first belt transport apparatus and the second belt transport apparatus can extend through the wash section, the rinse section, and the dry section. Each of the wash section and the rinse section can include a first spray nozzle configured to spray liquid downward onto the second surface of the panel, and a second spray nozzle configured to spray liquid upward onto the first surface of the panel. Each of the wash section and the rinse section can further include a collection volume configured to collect the liquid that runs off of the panel.

The dry section can include a first air spray head configured to spray air downward onto the second surface of the panel, and a second air spray head configured to spray air upward onto the first surface of the panel. The dry section can further include an angled surface configured to direct liquid collected during the drying process into the rinse section.

According to some implementations, the present disclosure relates to a method for cleaning a panel having electronic modules formed thereon. The method includes moving the panel constrained between a first belt transport apparatus and a second belt transport apparatus. The first belt transport apparatus is configured to support a first surface of the panel, and the second belt transport apparatus is configured to engage a second surface of the panel. The second belt transport apparatus includes a mesh, with the mesh having a coating configured to reduce the likelihood of damage to the second surface of the panel and to provide desired electrostatic discharge protection for the panel. The method further includes applying cleaning fluid onto the first surface and the second surface of the panel. The mesh of the second belt transport apparatus is configured to engage the second surface of the panel to thereby keep the panel on the first belt transport apparatus during the application of the cleaning fluid.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

The present disclosure relates to U.S. patent application Ser. No. ______ [Attorney Docket 75900-50015], titled “SYSTEMS AND METHODS RELATED TO ABLATION DURING MANUFACTURE OF RADIO-FREQUENCY MODULES,” filed on even date herewith and hereby incorporated by reference herein in its entirety.

### BRIEF DESCRIPTION OF THE DRAWINGS

FIG. 1 shows a process that can be implemented to fabricate a packaged module that includes a die having an integrated circuit (IC).

FIGS. 2A1 and 2A2 show front and back sides of an example laminate panel configured to receive a plurality of dies for formation of packaged modules.

FIGS. 2B1 to 2B3 show various views of a laminate substrate of the panel configured to yield an individual module.

FIG. 2C shows an example of a fabricated semiconductor wafer having a plurality of dies that can be singulated for mounting on the laminate substrate.

FIG. 2D depicts an individual die showing example electrical contact pads for facilitating connectivity when mounted on the laminate substrate.

FIGS. 2E1 and 2E2 show various views of the laminate substrate being prepared for mounting of example surface-mount technology (SMT) devices.

FIGS. 2F1 and 2F2 show various views of the example SMT devices mounted on the laminate substrate.

FIGS. 2G1 and 2G2 show various views of the laminate substrate being prepared for mounting of an example die.

FIGS. 2H1 and 2H2 show various views of the example die mounted on the laminate substrate.

FIGS. 2I1 and 2I2 show various views of the die electrically connected to the laminate substrate by example wirebonds.

FIGS. 2J1 and 2J2 show various views of wirebonds formed on the laminate substrate and configured to facilitate electromagnetic (EM) isolation between an area defined by the wirebonds and areas outside of the wirebonds.

FIG. 2K shows a side view of molding configuration for introducing molding compound to a region above the laminate substrate.

FIG. 2L shows a side view of an overmold formed via the molding configuration of FIG. 2K.

FIG. 2M shows the front side of a panel with the overmold.

FIG. 2N shows a side view of how an upper portion of the overmold can be removed to expose upper portions of the EM isolation wirebonds.

FIG. 2O shows a portion of a panel where a portion of the overmold has its upper portion removed to better expose the upper portions of the EM isolation wirebonds.

FIG. 2P shows a side view of a conductive layer formed over the overmold such that the conductive layer is in electrical contact with the exposed upper portions of the EM isolation wirebonds.

FIG. 2Q shows a panel where the conductive layer can be a spray-on metallic paint.

FIG. 2R shows individual packaged modules being cut from the panel.

FIGS. 2S1 to 2S3 show various views of an individual packaged module.

FIG. 2T shows that one or more of modules that are mounted on a circuit board such as a wireless phone board can include one or more features as described herein.

FIG. 3A shows a process that can be implemented to install a packaged module having one or more features as described herein on the circuit board of FIG. 2T.

FIG. 3B schematically depicts the circuit board with the packaged module installed thereon.

FIG. 3C schematically depicts a wireless device having the circuit board with the packaged module installed thereon.

FIG. 4 shows an ablation system that can be implemented to remove an upper surface of an overmold structure to better expose upper portions of shielding wirebonds.

FIG. 5 shows an example interior of the ablation system of FIG. 4.

FIG. 6 shows an example of a transport system that can be implemented in the ablation system of FIG. 4.

FIGS. 7A and 7B schematically show examples of a cleaning system that can be implemented to clean a panel after its upper surface of an overmold structure is ablated to facilitate spray-painting of an electrically conductive layer.

FIG. 8 schematically shows a belt transport apparatus that can be implemented in the cleaning system of FIG. 7.

FIG. 9 shows an example of a coated belt that can be utilized in the transport apparatus of FIG. 8, where the coated belt has desirable physical properties.

FIG. 10 shows a more specific example of the cleaning system of FIG. 7.

### DETAILED DESCRIPTION OF SOME EMBODIMENTS

The headings provided herein, if any, are for convenience only and do not necessarily affect the scope or meaning of the claimed invention.

Described herein are various examples of systems, apparatus, devices structures, materials and/or methods related to fabrication of packaged modules having a radio-frequency (RF) circuit and wirebond-based electromagnetic (EM) isolation structures. Although described in the context of RF circuits, one or more features described herein can also be utilized in packaging applications involving non-RF components. Similarly, one or more features described herein can also be utilized in packaging applications without the EM isolation functionality.

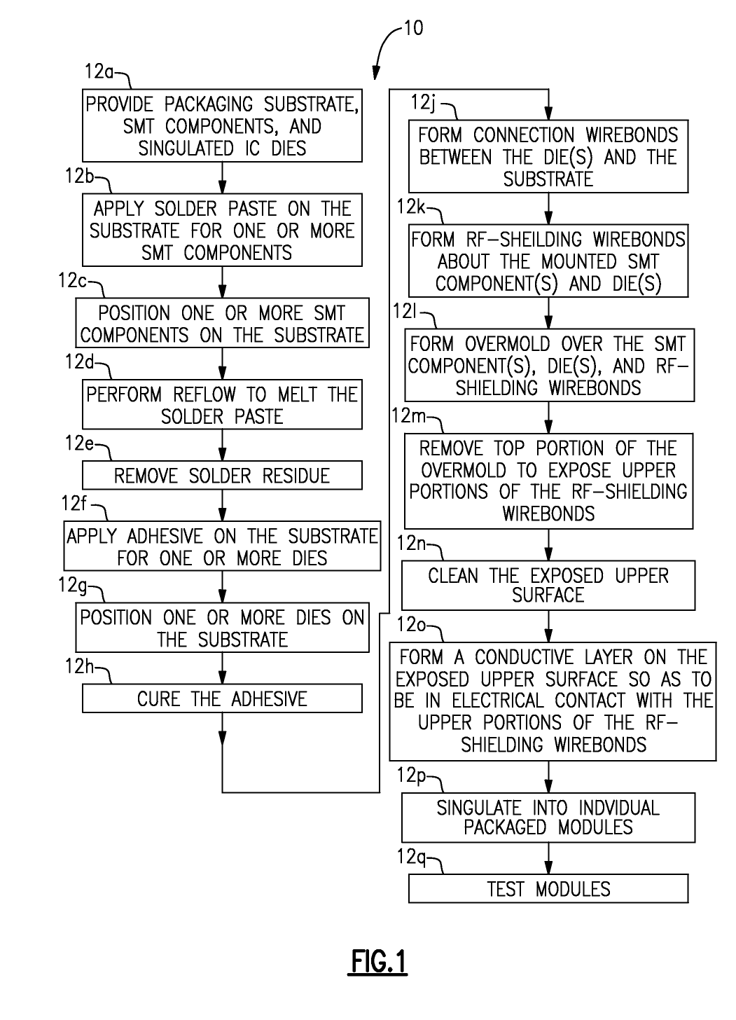

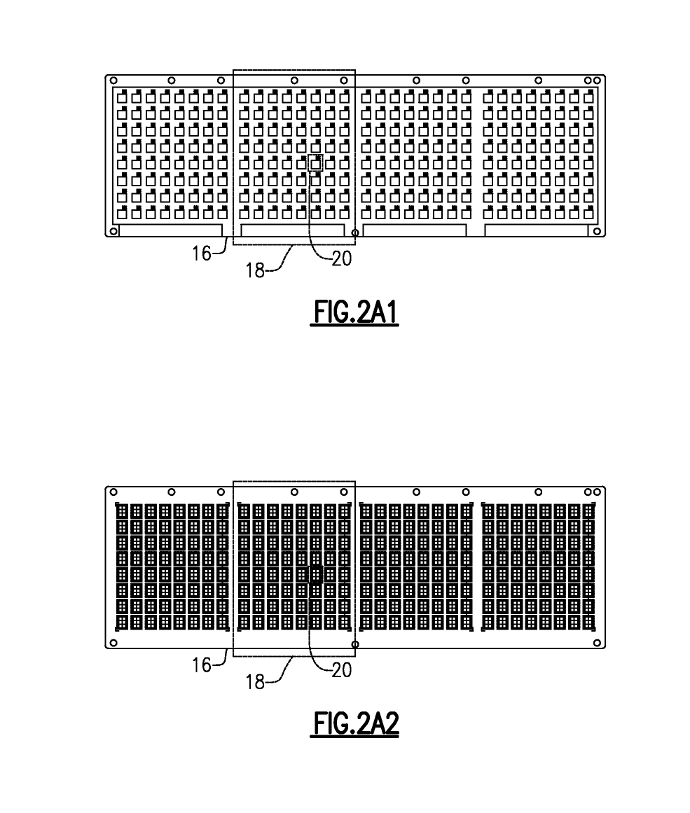

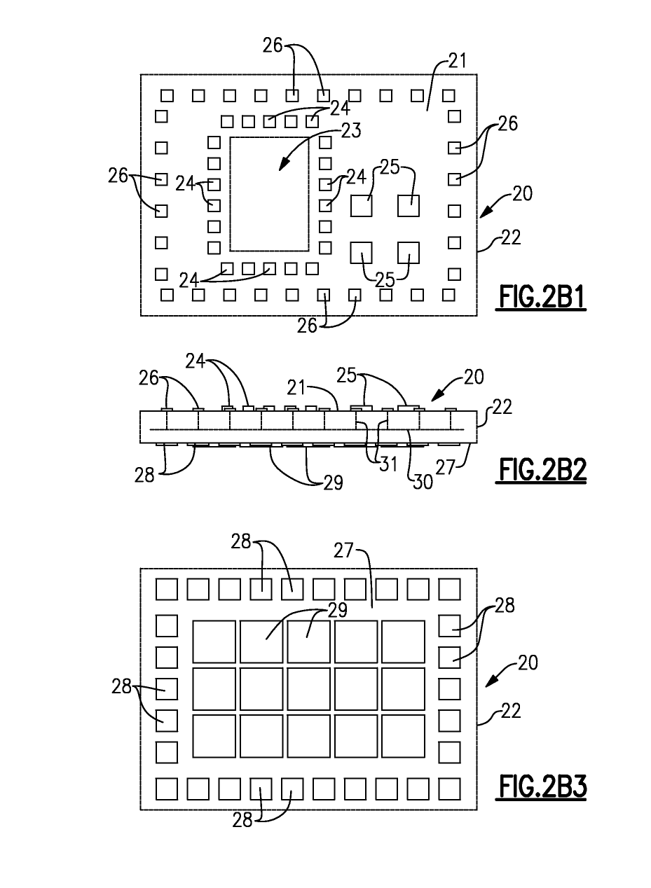

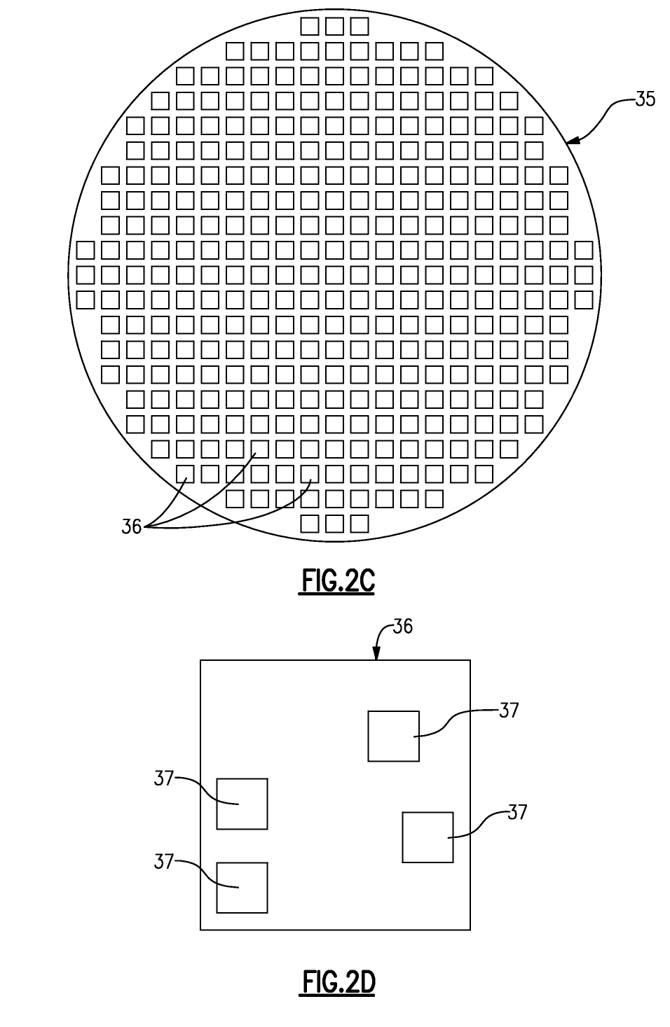

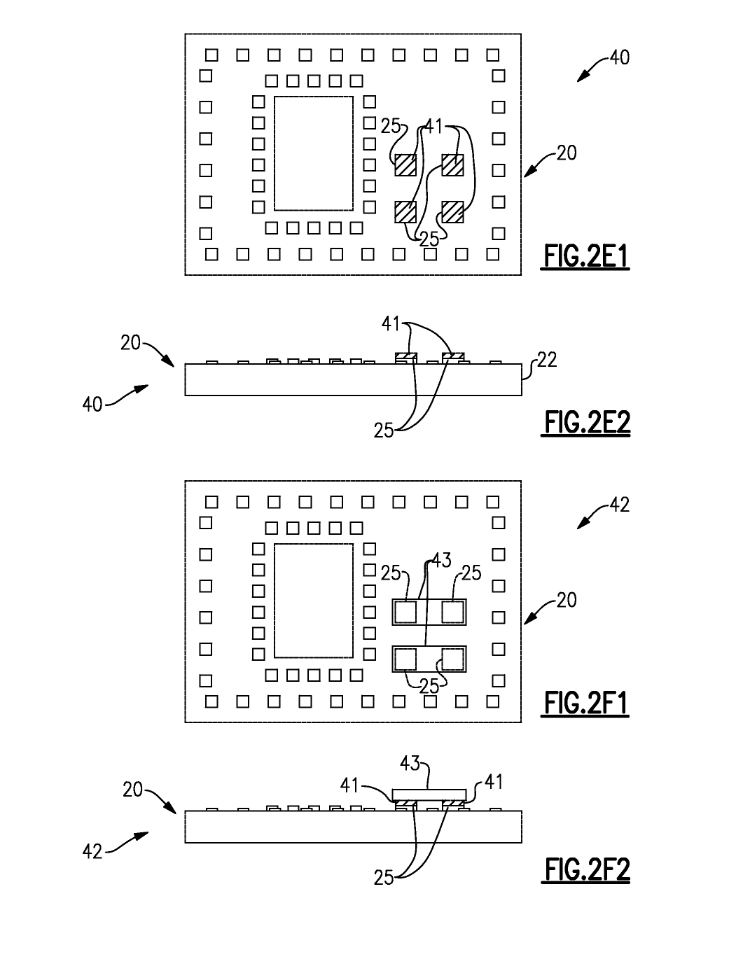

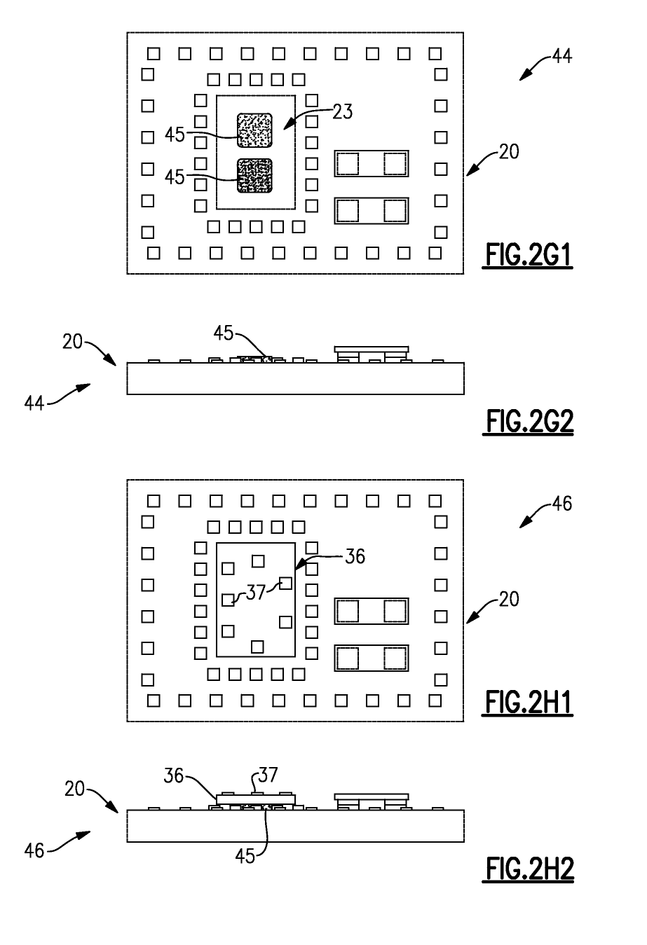

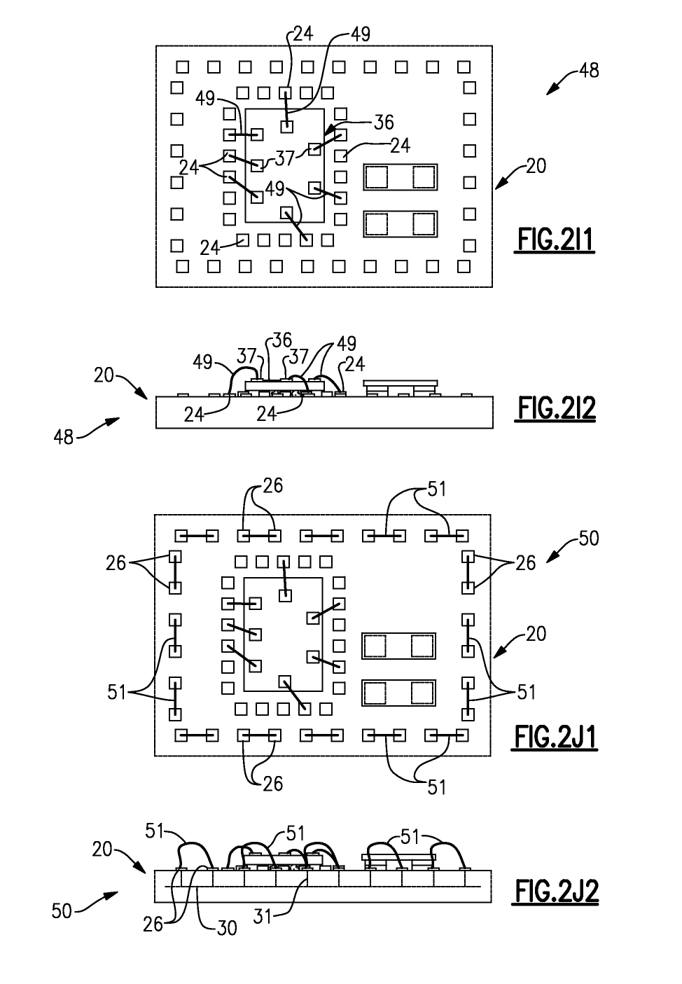

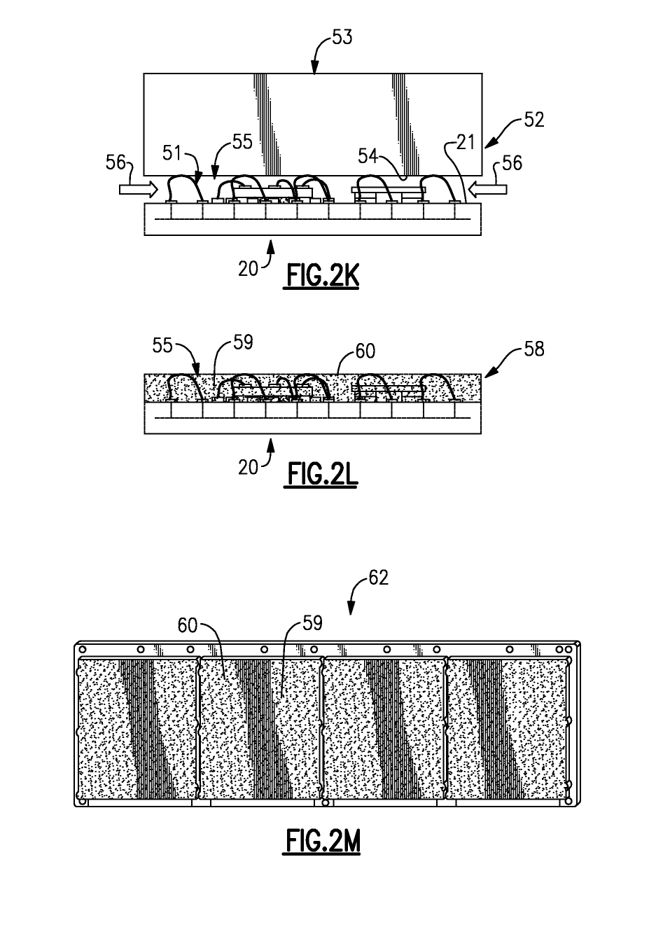

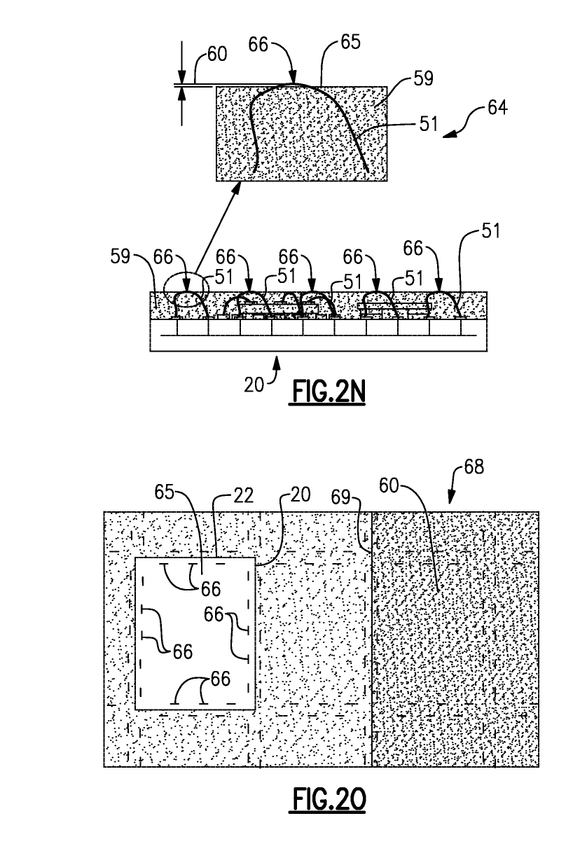

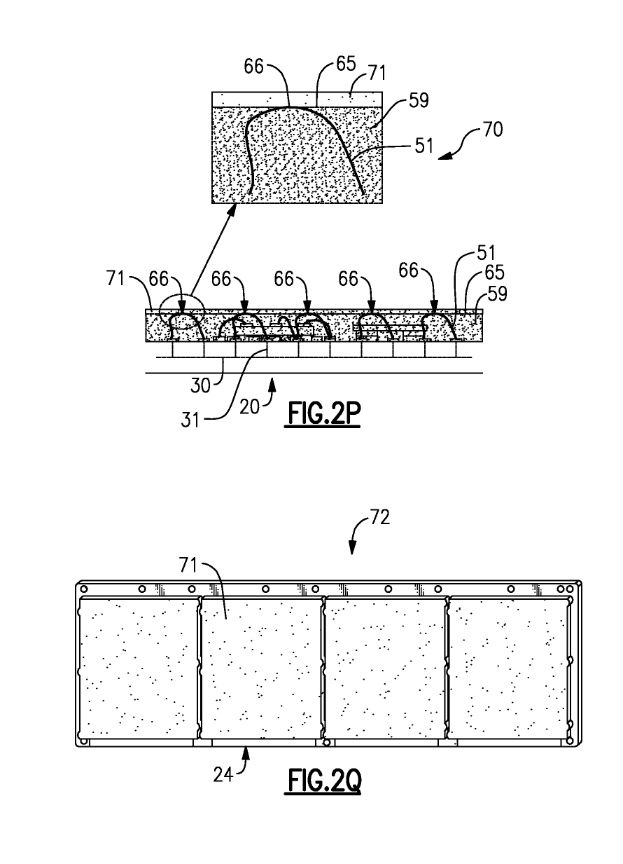

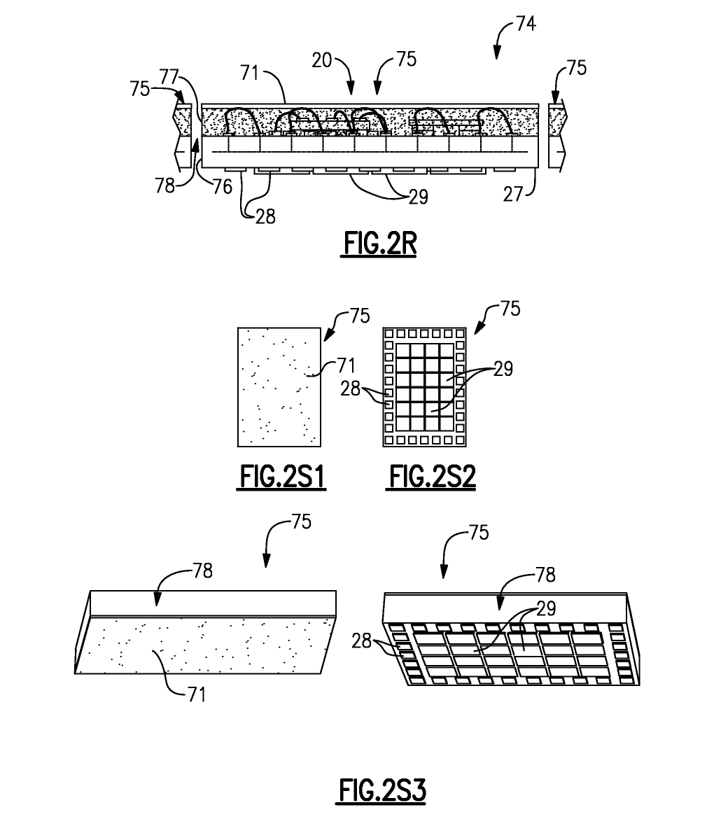

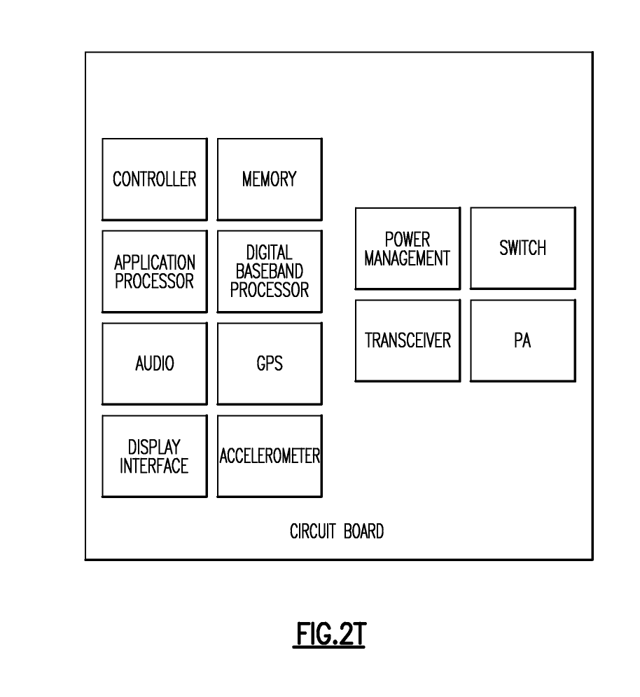

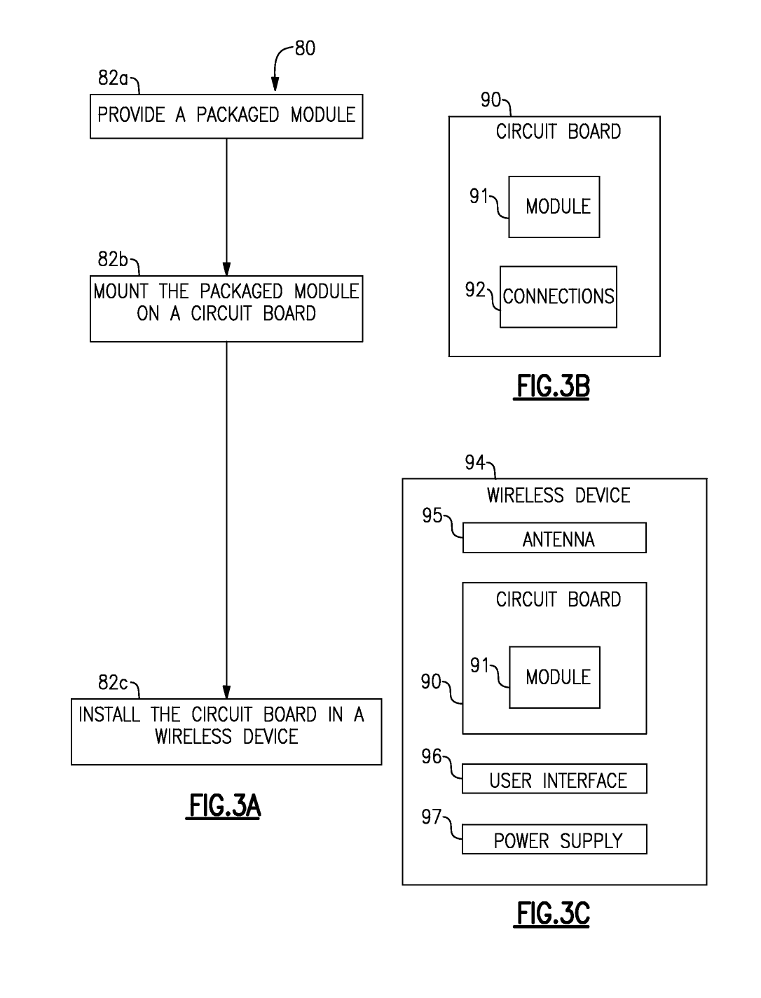

FIG. 1 shows a process 10 that can be implemented to fabricate a packaged module having and/or via one or more features as described herein. FIG. 2 shows various parts and/or stages of various steps associated with the process 10 of FIG. 1.

In block 12a of FIG. 1, a packaging substrate and parts to be mounted on the packaging substrate can be provided. Such parts can include, for example, one or more surface-mount technology (SMT) components and one or more singulated dies having integrated circuits (ICs). FIGS. 2A1 and 2A2 show that in some embodiments, the packaging substrate can include a laminate panel 16. FIG. 2A1 shows the example panel's front side; and FIG. 2A2 shows the panel's back side. The panel 16 can include a plurality of individual module substrates 20 arranged in groups that are sometimes referred to as cookies 18.

FIGS. 2B1-2B3 show front, side and back, respectively, of an example configuration of the individual module substrate 20. For the purpose of description herein, a boundary 22 can define an area occupied by the module substrate 20 on the panel 16. Within the boundary 22, the module substrate 20 can include a front surface 21 and a back surface 27. Shown on the front surface 21 is an example mounting area 23 dimensioned to receive a die (not shown). A plurality of example contact pads 24 (e.g., connection wirebond contact pads) are arranged about the die-receiving area 23 so as to allow formation of electrical connections between the die and contact pads 28 arranged on the back surface 27. Although not shown, electrical connections between the wirebond contact pads 24 and the module's contact pads 28 can be configured in a number of ways. Also within the boundary 22 are two sets of example contact pads 25 configured to allow mounting of, for example passive SMT devices (not shown). The contact pads 25 can be electrically connected to some of the module's contact pads 28 and/or ground contact pads 29 disposed on the back surface 27. Also within the boundary 22 are a plurality of wirebond pads 26 configured to allow formation of a plurality of EM-isolating wirebonds (not shown). The wirebond pads 26 can be electrically connected to an electrical reference plane (such as a ground plane) 30. Such connections between the wirebond pads 26 and the ground plane 30 (depicted as dotted lines 31) can be achieved in a number of ways. In some embodiments, the ground plane 30 may or may not be connected to the ground contact pads 29 disposed on the back surface 27.

FIG. 2C shows an example fabricated wafer 35 that includes a plurality of functional dies 36 awaiting to be cut (or sometimes referred to as singulated) into individual dies. Such cutting of the dies 36 can be achieved in a number of ways. FIG. 2D schematically depicts an individual die 36 where a plurality of metalized contact pads 37 can be provided. Such contact pads can be configured to allow formation of connection wirebonds between the die 36 and the contact pads 24 of the module substrate (e.g., FIG. 2B1).

In block 12b of FIG. 1, solder paste can be applied on the module substrate to allow mounting of one or more SMT devices. FIGS. 2E1 and 2E2 show an example configuration 40 where solder paste 41 is provided on each of the contact pads 25 on the front surface of the module substrate 20. In some implementations, the solder paste 41 can be applied to desired locations on the panel (e.g., 16 in FIG. 2A1) in desired amount by an SMT stencil printer.

In block 12c of FIG. 1, one or more SMT devices can be positioned on the solder contacts having solder paste. FIGS. 2F1 and 2F2 show an example configuration 42 where example SMT devices 43 are positioned on the solder paste 41 provided on each of the contact pads 25. In some implementations, the SMT devices 43 can be positioned on desired locations on the panel by an automated machine that is fed with SMT devices from tape reels.

In block 12d of FIG. 1, a reflow operation can be performed to melt the solder paste to solder the one or more SMT devices on their respective contact pads. In some implementations, the solder paste 41 can be selected and the reflow operation can be performed to melt the solder paste 41 at a first temperature to thereby allow formation of desired solder contacts between the contact pads 25 and the SMT devices 43.

In block 12e of FIG. 1, solder residue from the reflow operation of block 12d can be removed. By way of an example, the substrates can be run through a solvent or aqueous cleaning step. Such a cleaning step can be achieved by, for example, a nozzle spray, vapor chamber, or full immersion in liquid.

In block 12f of FIG. 1, adhesive can be applied on one or more selected areas on the module substrate 20 to allow mounting of one or more dies. FIGS. 2G1 and 2G2 show an example configuration 44 where adhesive 45 is applied in the die-mounting area 23. In some implementations, the adhesive 45 can be applied to desired locations on the panel (e.g., 16 in FIG. 2A1) in desired amount by techniques such as screen printing.

In block 12g of FIG. 1, one or more dies can be positioned on the selected areas with adhesive applied thereon. FIGS. 2H1 and 2H2 show an example configuration 46 where an example die 36 is positioned on the die-mounting area 23 via the adhesive 45. In some implementations, the die 36 can be positioned on the die-mounting area on the panel by an automated machine that is fed with dies from a tape reel.

In block 12h of FIG. 1, the adhesive between the die the die-mounting area can be cured. Preferably, such a curing operation can be performed at one or more temperatures that are lower than the above-described reflow operation for mounting of the one or more SMT devices on their respective contact pads. Such a configuration allows the solder connections of the SMT devices to remain intact during the curing operation.

In block 12j of FIG. 1, electrical connections such as wirebonds can be formed between the mounted die(s) and corresponding contact pads on the module substrate 20. FIGS. 211 and 212 show an example configuration 48 where a number of wirebonds 49 are formed between the contact pads 37 of the die 36 and the contact pads 24 of the module substrate 20. Such wirebonds can provide electrical connections for signals and/or power to and from one or more circuits of the die 36. In some implementations, the formation of the foregoing wirebonds can be achieved by an automated wirebonding machine.

In block 12k of FIG. 1, a plurality of RF-shielding wirebonds can be formed about a selected area on the module substrate 20. FIGS. 2J1 and 2J2 show an example configuration 50 where a plurality of RF-shielding wirebonds 51 are formed on wirebond pads 26. The wirebond pads 26 are schematically depicted as being electrically connected (dotted lines 31) with one or more reference planes such as a ground plane 30. In some embodiments, such a ground plane can be disposed within the module substrate 20. The foregoing electrical connections between the RF-shielding wirebonds 51 and the ground plane 30 can yield an interconnected RF-shielding structure at sides and underside of the area defined by the RF-shielding wirebonds 51. As described herein, a conductive layer can be formed above such an area and connected to upper portions of the RF-shielding wirebonds 51 to thereby form an RF-shielded volume.

In the example configuration 50, the RF-shielding wirebonds 51 are shown to form a perimeter around the area where the die (36) and the SMT devices (43) are located. Other perimeter configurations are also possible. For example, a perimeter can be formed with RF-wirebonds around the die, around one or more of the SMT devices, or any combination thereof. In some implementations, an RF-wirebond-based perimeter can be formed around any circuit, device, component or area where RF-isolation is desired. For the purpose of description, it will be understood that RF-isolation can include keeping RF signals or noise from entering or leaving a given shielded area.

In the example configuration 50, the RF-shielding wirebonds 51 are shown to have an asymmetrical side profile configured to facilitate controlled deformation during a molding process as described herein. Additional details concerning such wirebonds can be found in, for example, PCT Publication No. WO 2010/014103 titled “SEMICONDUCTOR PACKAGE WITH INTEGRATED INTERFERENCE SHIELDING AND METHOD OF MANUFACTURE THEREOF.” In some embodiments, other shaped RF-shielding wirebonds can also be utilized. For example, generally symmetric arch-shaped wirebonds as described in U.S. Pat. No. 8,071,431, titled “OVERMOLDED SEMICONDUCTOR PACKAGE WITH A WIREBOND CAGE FOR EMI SHIELDING,” can be used as RF-shielding wirebonds in place of or in combination with the shown asymmetric wirebonds. In some embodiments, RF-shielding wirebonds do not necessarily need to form a loop shape and have both ends on the surface of the module substrate. For example, wire extensions with one end on the surface of the module substrate and the other end positioned above the surface (for connecting to an upper conductive layer) can also be utilized.

In the example configuration 50 of FIGS. 2J1 and 2J2, the RF-shielding wirebonds 51 are shown to have similar heights that are generally higher than heights of the die-connecting wirebonds (49). Such a configuration allows the die-connecting wirebonds (49) to be encapsulated by molding compound as described herein, and be isolated from an upper conductive layer to be formed after the molding process.

In block 121 of FIG. 1, an overmold can be formed over the SMT component(s), die(s), and RF-shielding wirebonds. FIG. 2K shows an example configuration 52 that can facilitate formation of such an overmold. A mold cap 53 is shown to be positioned above the module substrate 20 so that the lower surface 54 of the mold cap 53 and the upper surface 21 of the module substrate 20 define a volume 55 where molding compound can be introduced.

In some implementations, the mold cap 53 can be positioned so that its lower surface 54 engages and pushes down on the upper portions of the RF-shielding wirebonds 51. Such a configuration allows whatever height variations in the RF-shielding wirebonds 51 to be removed so that the upper portions touching the lower surface 54 of the mold cap 53 are at substantially the same height. When the mold compound is introduced and an overmold structure is formed, the foregoing technique maintains the upper portions of the encapsulated RF-shielding wirebonds 51 at or close to the resulting upper surface of the overmold structure.

In the example molding configuration 52 of FIG. 2K, molding compound can be introduced from one or more sides of the molding volume 55 as indicated by arrows 56. In some implementations, such an introduction of molding compound can be performed under heated and vacuum condition to facilitate easier flow of the heated molding compound into the volume 55.

FIG. 2L shows an example configuration 58 where molding compound has been introduced into the volume 55 as described in reference to FIG. 2K and the molding cap removed to yield an overmold structure 59 that encapsulates the various parts (e.g., die, die-connecting wirebonds, and SMT devices). The RF-shielding wirebonds are also shown to be substantially encapsulated by the overmold structure 59. The upper portions of the RF-shielding wirebonds are shown to be at or close to the upper surface 60 of the overmold structure 59.

FIG. 2M shows an example panel 62 that has overmold structures 59 formed over the multiple cookie sections. Each cookie section's overmold structure can be formed as described herein in reference to FIGS. 2K and 2L. The resulting overmold structure 59 is shown to define a common upper surface 60 that covers the multiple modules of a given cookie section.

The molding process described herein in reference to FIGS. 2K-2M can yield a configuration where upper portions of the encapsulated RF-shielding wirebonds are at or close to the upper surface of the overmold structure. Such a configuration may or may not result in the RF-shielding wirebonds forming a reliable electrical connection with an upper conductor layer to be formed thereon.

In block 12m of FIG. 1, a top portion of the overmold structure can be removed to better expose upper portions of the RF-shielding wirebonds.

FIG. 2N shows an example configuration 64 where such a removal has been performed. In the example, the upper portion of the overmold structure 59 is shown to be removed to yield a new upper surface 65 that is lower than the original upper surface 60 (from the molding process). Such a removal of material is shown to better expose the upper portions 66 of the RF-shielding wirebonds 51.

The foregoing removal of material from the upper portion of the overmold structure 59 can be achieved in a number of ways. FIG. 2O shows an example configuration 68 where such removal of material is achieved by sand-blasting. In the example, the left portion is where material has been removed to yield the new upper surface 65 and better exposed upper portions 66 of the RF-shielding wirebonds. The right portion is where material has not been removed, so that the original upper surface 60 still remains. The region indicated as 69 is where the material-removal is being performed.

In the example shown in FIG. 2O, a modular structure corresponding to the underlying module substrate 20 (depicted with a dotted box 22) is readily apparent from the exposed upper portions 66 of the RF-shielding wirebonds that are mostly encapsulated by the overmold structure 59. Such modules will be separated after a conductive layer is formed over the newly formed upper surface 65.

In block 12n of FIG. 1, the new exposed upper surface resulting from the removal of material can be cleaned. By way of an example, the substrates can be run through a solvent or aqueous cleaning step. Such a cleaning step can be achieved by, for example, a nozzle spray, or full immersion in liquid.

In block 12o of FIG. 1, an electrically conductive layer can be formed on the new exposed upper surface of the overmold structure, so that the conductive layer is in electrical contact with the upper portions of the RF-shielding wirebonds. Such a conductive layer can be formed by a number of different techniques, including methods such as spraying or printing.

FIG. 2P shows an example configuration 70 where an electrically conductive layer 71 has been formed over the upper surface 65 of the overmold structure 59. As described herein, the upper surface 65 better exposes the upper portions 66 of the RF-shielding wirebonds 51. Accordingly, the formed conductive layer 71 forms improved contacts with the upper portions 66 of the RF-shielding wirebonds 51.

As described in reference to FIG. 2J, the RF-shielding wirebonds 51 and the ground plane 30 can yield an interconnected RF-shielding structure at sides and underside of the area defined by the RF-shielding wirebonds 51. With the upper conductive layer 71 in electrical contact with the RF-shielding wirebonds 51, the upper side above the area is now shielded as well, thereby yielding a shielded volume.

FIG. 2Q shows an example panel 72 that has been sprayed with conductive paint to yield an electrically conductive layer 71 that covers multiple cookie sections. As described in reference to FIG. 2M, each cookie section includes multiple modules that will be separated.

In block 12p of FIG. 1, the modules in a cookie section having a common conductive layer (e.g., a conductive paint layer) can be singulated into individual packaged modules. Such singulation of modules can be achieved in a number of ways, including a sawing technique.

FIG. 2R shows an example configuration 74 where the modular section 20 described herein has been singulated into a separated module 75. The overmold portion is shown to include a side wall 77; and the module substrate portion is shown to include a side wall 76. Collectively, the side walls 77 and 76 are shown to define a side wall 78 of the separated module 75. The upper portion of the separated module 75 remains covered by the conductive layer 71. As described herein in reference to FIG. 2B, the lower surface 27 of the separated module 75 includes contact pads 28, 29 to facilitate electrical connections between the module 75 and a circuit board such as a phone board.

FIGS. 2S1, 2S2 and 2S3 show front (also referred to as top herein), back (also referred to as bottom herein) and perspective views of the singulated module 75. As described herein, such a module includes RF-shielding structures encapsulated within the overmold structure; and in some implementations, the overall dimensions of the module 75 is not necessarily any larger than a module without the RF-shielding functionality. Accordingly, modules having integrated RF-shielding functionality can advantageously yield a more compact assembled circuit board since external RF-shield structures are not needed. Further, the packaged modular form allows the modules to be handled easier during manipulation and assembly processes.

In block 12q of FIG. 1, the singulated modules can be tested for proper functionality. As discussed above, the modular form allows such testing to be performed easier. Further, the module's internal RF-shielding functionality allows such testing to be performed without external RF-shielding devices.

FIG. 2T shows that in some embodiments, one or more of modules included in a circuit board such as a wireless phone board can be configured with one or more packaging features as described herein. Non-limiting examples of modules that can benefit from such packaging features include, but are not limited to, a controller module, an application processor module, an audio module, a display interface module, a memory module, a digital baseband processor module, GPS module, an accelerometer module, a power management module, a transceiver module, a switching module, and a power amplifier module.

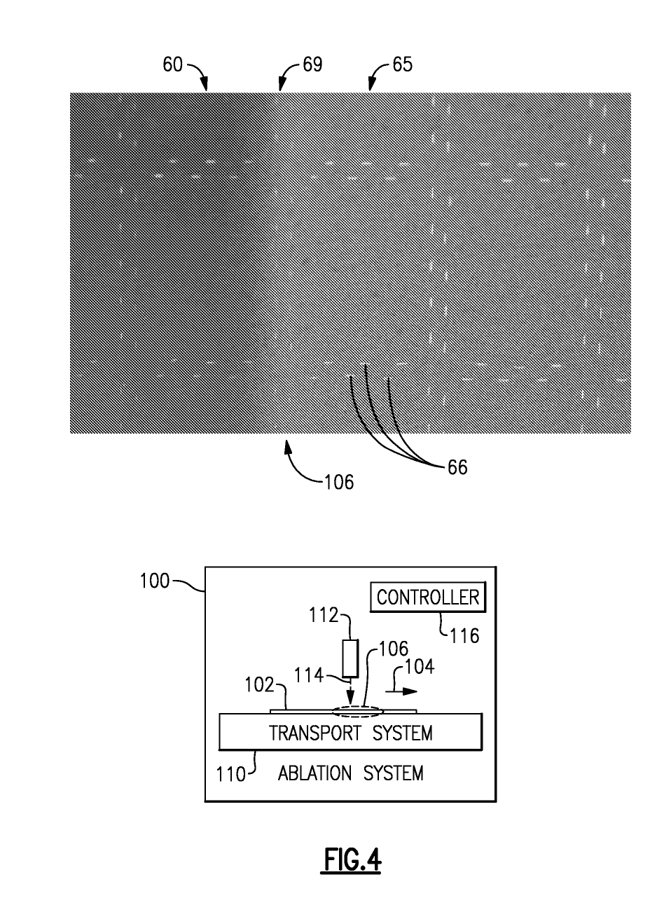

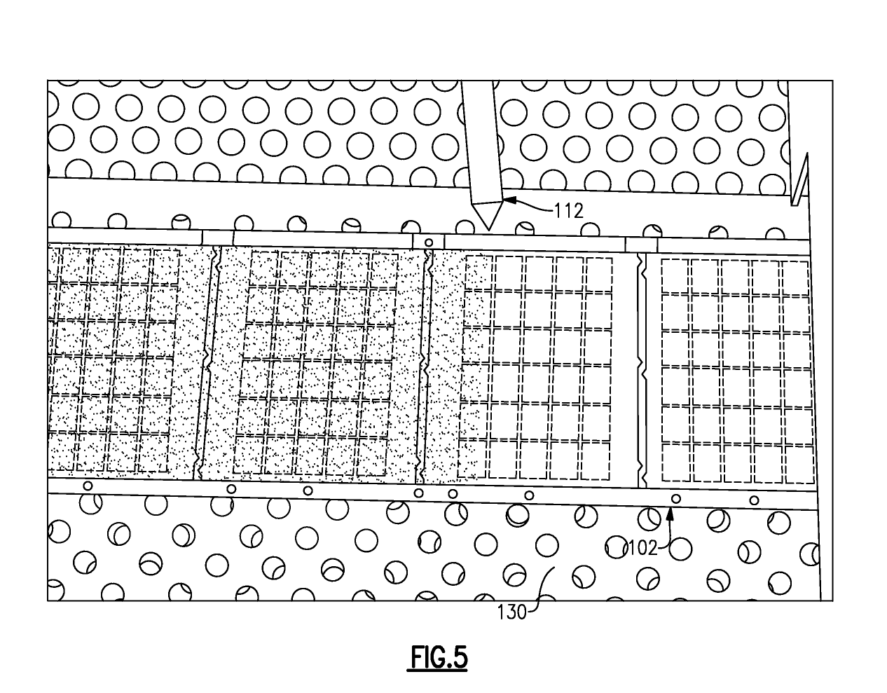

FIG. 3A shows a process 80 that can be implemented to assemble a packaged module having one or more features as described herein on a circuit board. In block 82a, a packaged module can be provided. In some embodiments, the packaged module can represent a module described in reference to FIG. 2T. In block 82b, the packaged module can be mounted on a circuit board (e.g., a phone board). FIG. 3B schematically depicts a resulting circuit board 90 having module 91 mounted thereon. The circuit board can also include other features such as a plurality of connections 92 to facilitate operations of various modules mounted thereon.

In block 82c, a circuit board having modules mounted thereon can be installed in a wireless device. FIG. 3C schematically depicts a wireless device 94 (e.g., a cellular phone) having a circuit board 90 (e.g., a phone board). The circuit board 90 is shown to include a module 91 having one or more features as described herein. The wireless device is shown to further include other components, such as an antenna 95, a user interface 96, and a power supply 97.

### Ablation:

As described in reference to FIGS. 2N and 2O, an overmold structure (59) formed on a panel containing multiple modular devices (yet to be singulated) can have its upper surface removed (e.g., by ablation) to expose upper portions (66) of shielding wirebonds (51) buried in the overmold. Exposure of such shielding wirebonds' upper portions (66) allows improved electrical contacts between the shielding wirebonds (51) and an electrically conductive layer (71 in FIG. 2P).

In some implementations, the foregoing removal of the upper surface of the overmold can be achieved by utilizing a micro-ablation technique. FIG. 4 shows a system 100 that can be configured to perform such an ablation process. The system 100 is shown to include a transport system 110 configured to provide movement (arrow 104) of an overmolded panel 102 to a region where an ablating spray 114 can be provided by a blast head 112, during application of such an ablating spray, and away from the ablating region. Examples of such a transport system are described herein in greater detail.

A portion 106 of the panel 102 is shown in greater detail, where the ablated region (lighter shade) is indicated as 65. The upper portions 66 of the shielding wirebonds are shown to be exposed by the ablation process. The un-ablated region (darker shade) is indicated as 60, and the region being ablated is indicated as 69.

FIG. 4 further shows that in some implementations, the ablation system 100 can include a controller 116 configured to control a number of operations performed by the system 100. For example, a plurality of panels being processed by the system 100 can be tracked, and the blast head 112 can be operated based on such tracking of the panels. Examples of such control features are described herein in greater detail.

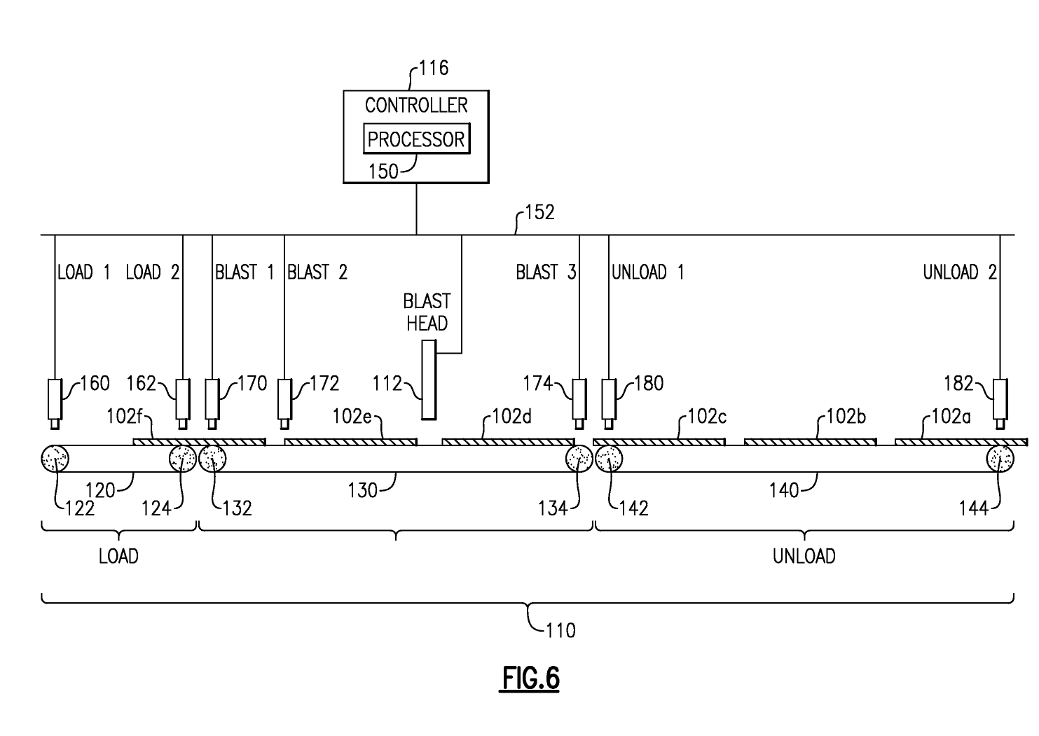

FIG. 5 shows an interior view of an ablation apparatus that can be a part of the system 100 of FIG. 4. A blast head 112 is shown to be in the process of ablating a panel 102 that is moving or movable relative to the blast head 112 on a conveyor belt 130. As described herein, such a belt can be configured to withstand harsh conditions resulting from repeated exposure to the spray pattern of the blast head 112. Also as described herein, the conveyor belt 130 can be combined with one or more other conveyor belts so as to generally retain the blast particles within a selected region.

FIG. 6 shows that in some implementations, the transport system 110 of FIG. 4 can include blast belt section that is separate from a loading belt section and an unloading belt section. The loading belt section, the blast belt section, and the unloading belt section can be arranged in an in-line arrangement.

In such an in-line arrangement, a panel loaded on the loading belt section moves towards the blasting area underneath the blast head 112. Once the panel reaches the end of the loading belt section, it is transferred to the blast belt section and continues to move towards the blasting area.

As the panel continues its motion on the blast belt, the blast head can be activated as described herein to thereby ablate the upper surface of the panel. Once the ablated panel reaches the end of the blast belt section, it is transferred to the unloading belt section. The panel can be removed from the transport system 110 after leaving the unloading belt section.

Based on the foregoing example, one can see that the close proximity of the belt sections arranged in the in-line manner allows the foregoing load-blast-unload transport to be performed effectively. However, because the loading belt section and the unloading belt section are separate from blast belt section, they remain away from the ablating region underneath the blast head 112. Accordingly, the loading and unloading belt sections are not subjected to the harsh conditions associated with the ablating process. Further, the blasting particles that accumulate on the blast belt section generally do not get transferred to, for example, the unloading belt section.

In some embodiments, the independent series of loading, blast, unloading belt sections can be implemented as shown in FIG. 6. The loading belt section can include a belt loop 120 that circulates around pulleys 122, 124, with one or both of the pulleys being powered. The blast belt section can include a belt loop 130 that circulates around pulleys 132, 134, with one or both of the pulleys being powered. The unloading belt section can include a belt loop 140 that circulates around pulleys 142, 144, with one or both of the pulleys being powered.

In some embodiments, the belt loops 120 and 140 for the loading and unloading sections can include a standard O-ring or flat belt formed from conductive material and having a thickness in a range of about 0.050 inch to 0.200 inch, or about 0.050 inch to 0.100 inch, depending on application. The thicknesses of the belts for the loading and unloading sections may or may not be the same. The widths of the belts for the loading and unloading sections may or may not be the same, and can be selected to accommodate panels with different widths. Similarly, the lengths of the belts for the loading and unloading sections may or may not be the same, and can be selected to accommodate, for example, different loading and unloading configurations.

In some embodiments, the belt loop 130 for the blast section can be configured to be resilient to exposure to blasting operations, and can include a full width flat belt to support substantially all of the panel as it is being ablated. Materials for such a belt is preferably sufficiently conductive for proper electrostatic discharge (ESD) protection, and also have mechanical properties such as being resiliently soft to absorb the impact energy of the blasting media without having parts of the belt ablated off.

In some embodiments, and as shown in the example of FIG. 5, the flat belt of the belt loop 130 of the blast section can include punched holes dimensioned to allow some of blasting media to fall through. Blasting media that accumulate between the holes can also fall when that portion of the flat belt in inverted in a return portion of the belt loop 130.

In some embodiments, the flat belt of the belt loop 130 can have a thickness in a range of about 0.050 inch to 0.200 inch, or about 0.050 inch to 0.100 inch, depending on application. The width of the flat belt for the blast section can be selected to accommodate panels with different widths. Similarly, the length of the flat belt for the blast section can be selected to accommodate, for example, various blasting and/or throughput configurations.

FIG. 6 further shows that in some embodiments, an ablating system can include a plurality of sensors that facilitate monitoring of the progress of the panels being processed. For example, “Load 1” and “Load 2” sensors 160, 162 can detect when a panel enters and leaves the loading section. Similarly, “Blast 1” and “Blast 3” sensors 170, 174 can detect when a panel enters and leaves the blast section. Similarly, “Unload 1” and “Unload 2” sensors 180, 182 can detect when a panel enters and leaves the unloading section.

In some embodiments, a sensor 172 (“Blast 2”) can be provided to activate and deactivate the blast head 112. By way of an example, the sensor 172 can be positioned from the blast head 112 by a distance that is slightly longer than the length of a panel. In FIG. 6, a panel 102e is shown to have passed by the sensor 172, and its trailing edge has been detected by the sensor 172. Upon such a detection, the blast head 112 can continue its blasting operation (e.g., from blasting of panel 102d) if a leading edge of a following panel (e.g., 102f) is detected within a selected window of time. If such a leading edge is not detected within the selected time window, the blast head can be deactivated until the next activating condition.

In some embodiments, the sensors 160, 162, 170, 172, 174, 180 and 182 can be proximity sensors that detect presence and/or absence of the panels at selected locations of the belts. For example, a proximity sensor can be a metal-detecting sensor such as an inductive sensor which detects a metal layer present within, for example, a laminate packaging substrate. Such proximity sensors can be desirable, since they are generally not affected by ablation debris.

In some embodiments, the foregoing examples of sensing and controlling functionalities can be controlled by a controller 116 in communication with at least some of the sensors (160, 162, 170, 172, 174, 180, 182) and the blast head 112 via, for example, a bus 152. In some embodiments, the controller 116 can include a processor 150 configured to process information representative of sensed signals and/or to coordinate the operation of the blast head 112. In some embodiments, the controller 116 can be configured to be in communication with a computer-readable medium (CRM) for storing, for example, various computer-executable instructions for performing and/or inducing various functionalities associated with the controller 116. In some implementations, such computer-executable instructions can be stored in a non-transitory manner.

In some implementations, the transport system 110 having one or more features as described herein can allow integration of the ablating system 100 with another system (e.g., painting/drying system). Automated input and output for the ablating system 100 can also be implemented. For example, the three independent belts along with the tracking sensors can be configured to allow use of readily available loader/unloader units using an existing protocol (e.g., a SMEMA (Surface Mount Equipment Manufacturers Association) protocol) to effectuate, for example, a magazine-to-magazine hands-free automated ablation process.

### Cleaning:

As described in reference to FIGS. 2N and 2O, an overmold structure (59) formed on a panel containing multiple modular devices (yet to be singulated) can have its upper surface removed (e.g., by ablation) to expose upper portions (66) of shielding wirebonds (51) buried in the overmold. Exposure of such shielding wirebonds' upper portions (66) allows improved electrical contacts between the shielding wirebonds (51) and an electrically conductive layer (71 in FIG. 2P). As described in reference to FIGS. 2P and 2Q, such a conductive layer (71) can be applied by, for example, spraying of an electrically conductive paint. Prior to such a painting process, it is generally desirable to clean the ablated surface (65) to promote improved formation of the electrically conductive paint layer.

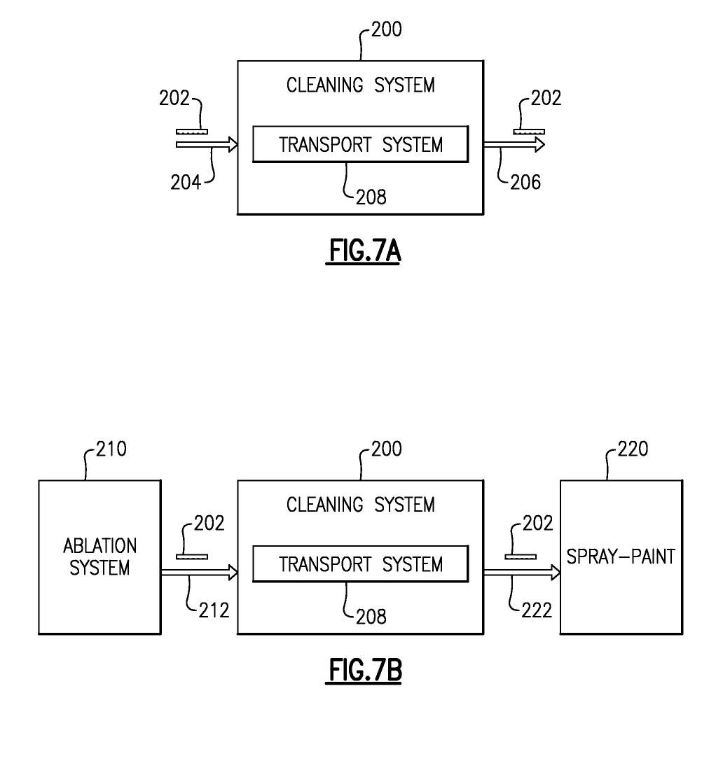

FIG. 7A schematically shows a cleaning system 200 that can be configured to perform such cleaning of ablated panels 202. Although described in the context of cleaning such ablated panels, it will be understood that one or more features related to the cleaning examples as described herein can also be utilized in other applications.

In FIG. 7A, a panel 202 to be cleaned is shown to be provided to the cleaning system 200 as an input (arrow 204). A cleaned panel 202 is shown to be leaving the cleaning system 200 as an output (arrow 206). In some embodiments, such input and output of the panels 202 can be implemented as manual loading/unloading operations, as automatic operations (e.g., utilizing magazine loaders and unloaders), or some combination thereof.

FIG. 7A further shows that the cleaning system 200 can include a transport system 208 configured to facilitate movement of the panels 202 as they undergo the cleaning process. Various examples of such a transport system are described herein in greater detail.

FIG. 7B shows that in some embodiments, a cleaning system 200 can be implemented as a part of an in-line process system. The cleaning system 200 is shown to receive as an input (arrow 212) a panel 202 that has been ablated and output by an ablation system 210. The cleaning system 200 is then shown to output (arrow 222) a cleaned panel 202 to be provided to a spray-paint system 220. Similar to the example shown in FIG. 7A, the cleaning system 200 of FIG. 7B is shown to include a transport system 208 configured to facilitate movement of the panels 202 as they undergo the cleaning process.

In some implementations, the present disclosure relates to the foregoing transport system 208 of the cleaning system 200. In some embodiments, such a transport system can be configured to prevent or reduce the likelihood of damage to the exposed shielding wirebonds (e.g., exposed portions 66 in FIG. 4) during the cleaning process. In some embodiments, the transport system 208 can also be configured to include a desirable ESD property. Examples of the foregoing properties are described herein in greater detail.

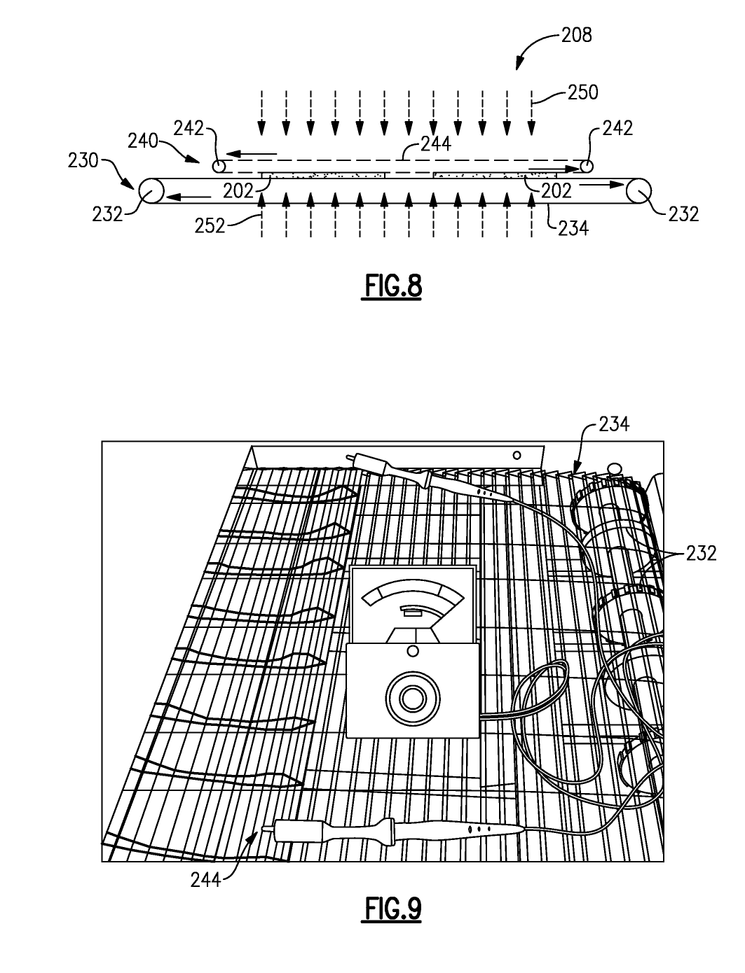

FIG. 8 shows an example configuration of a transport system 208 that can be implemented in the cleaning system 200 to securely move the panels 202 during the cleaning process. In the example depicted in FIG. 8, a given panel is shown to move from left to right. Such a movement can be facilitated by a mesh belt 234 of a lower belt transport apparatus 230. The belt 234 can be wrapped around rotating wheels 232 that rotate clockwise in the example.

The cleaning system 200 is further shown to provide a liquid spray (depicted as arrows 250) to the upper side (e.g., the ablated side) of the panels 202. Such a liquid can include, for example, a cleaning liquid or a rinsing liquid (e.g., water). A liquid spray (depicted as arrows 252) can also be directed upwards to clean the underside (e.g., the side with I/O and grounding pads). As describe herein, air can also be sprayed downward and/or upward to facilitate removal of liquids. As described herein, a fluid can represent either or both of a liquid or a gas (e.g., air), and the arrows 250 and 252 can represent sprays of such fluids.

If the panels 202 being transported on the mesh belt 234 are not held down, such an upward spraying fluid 252 can result in the panels 202 flying off or lifted from the mesh belt 234. To keep the panels 202 from such undesired displacement during the cleaning process, an upper belt apparatus 240 can be provided. Such an apparatus can include a belt 244 wrapped around wheels 242, and the wheels 242 can rotate (e.g., counter-clockwise) so that the belt 244 cooperates with the belt 234 of the lower belt apparatus 230 to facilitate the example left-to-right movement of the panels 202. The belt 244 can engage the upper surface (e.g., the ablated surface 65) of the panels 202 to thereby keep the panels 202 on the belt 234 during the cleaning process.

In some implementations, both of the lower and upper belts 234 and 244 are preferably electrically conductive to meet electrostatic discharge (ESD) requirements (e.g., conductivity preventing build-up of large ESD charges) since the content of the panel 202 is typically highly susceptible to ESD. Applicant has observed that a metal mesh belt (e.g., stainless steel mesh belt) provides such conductivity for ESD requirements. However, Applicant has also observed that a bare metal mesh belt used for the upper belt 244 can result in the metal mesh rubbing against relatively soft exposed wires (e.g., 66 in FIG. 4). Such rubbing can result the exposed wires being smashed, or in some cases, being broken completely. Such damages to the exposed wires can directly impact the functionality and/or reliability of the RF shielding structure formed with the shielding wirebonds (e.g., 51 in FIG. 2N).

In some implementations, the present disclosure relates to a mesh belt configured to engage a surface (such as an ablated surface with exposed portions of shielding wirebonds) of a panel, where the mesh belt includes a desirable ESD property (such as being electrically conductive) and mechanical properties of desired smoothness and softness to, for example, reduce or eliminate damages to the exposed wires on the engaged panel surface. In some embodiments, such a mesh belt can include a metal (e.g., stainless steel) mesh belt that is coated with material having the foregoing properties. By way of an example, coating a stainless steel mesh using a fluoropolymer with small conductive particles mixed in results in a coated mesh that is sufficiently conductive for ESD purposes and has smoothness and softness properties to generally not damage the exposed wires during the cleaning process. Other coating compositions and/or methods can also be implemented. Further, it will be understood that although the foregoing mesh belt is described in the context of coating to provide desired properties, a mesh belt formed from materials having such properties without coating can also be utilized.

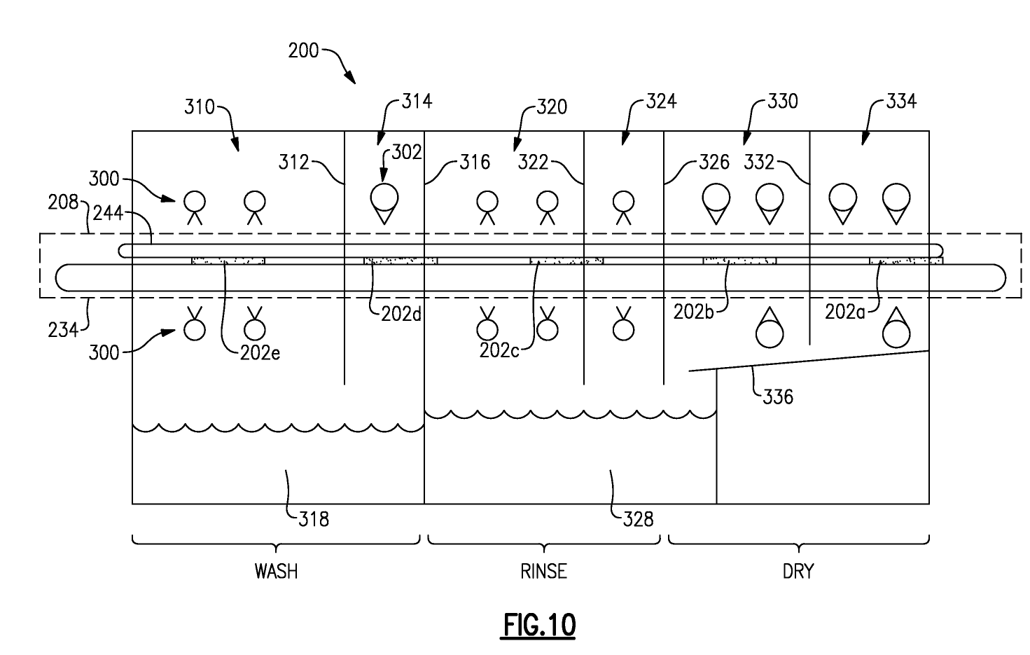

FIG. 9 shows an example configuration of the mesh belt 234 of the lower transport apparatus (230 in FIG. 8) and the mesh belt 244 of the upper transport apparatus (240). The lower mesh belt 234 is shown to be wrapped around a plurality of wheels 232. Wheels are not shown for the upper mesh belt 244.

In the example of FIG. 9, the lower mesh belt 234 is formed from bare stainless steel, and the upper mesh belt 244 is coated with the foregoing example coating material having fluoropolymer with small conductive particles mixed in. As described herein, such a coated upper mesh belt can engage the ablated surfaces of the panels during cleaning processes to keep the panels on the lower mesh belt, and not damage the exposed wires on the ablated surfaces.

In the example of FIG. 9, resistance measurement is being made to demonstrate desired electrical conductivity. Such measurements among two samples yielded resistance of approximately 1×10⁵ ohms (generally between two sides of the upper mesh belt 244) for both samples, which is within a desired resistance (R) range of 1×10⁴≦R≦1×10¹¹ ohms. In some embodiments, the upper mesh belt 244 can have a resistance value between two surface locations at or near their respective sides so as to categorize the upper mesh belt 244 as a conductive ESD protective device (e.g., resistance between 1 KΩ and 1 MSΩ) or as a dissipative ESD protective device (e.g., resistance between 1 MSΩ and 1 TΩ).

In some embodiments, a panel transport system having one or more features as described in reference to FIGS. 7-9 can be implemented in an example cleaning system 200 schematically depicted in FIG. 10. The example cleaning system 200 is shown to include a transport system 208 having a lower mesh belt 234 and an upper mesh belt 244 operating together to move panels 202a-202e from an input (e.g., left side) to an output (e.g., right side) of the cleaning system 200.

In the context of the panels being oriented so that their ablated surfaces face upward, the upper mesh belt 244 can be coated or otherwise configured to provide desired functionalities as described herein. If the panels are oriented so that their ablated surfaces face downward, the lower mesh belt 234 can be coated or otherwise configured to provide desired functionalities as described herein. In some embodiments, both of the upper and lower mesh belts 244, 234 can be coated or otherwise configured to provide desired functionalities as described herein.

The example cleaning system 200 is shown to include a wash section, a rinse section that follows the wash section, and a dry section that follows the rinse section. In the context of the panels 202 having their ablated surfaces facing upward, the wash section is shown to include a liquid spray section 310 and an air spray section 314.

The liquid spray section 310 is shown to include, for example, two liquid spray nozzles 300 positioned to spray cleaning liquid on to the upper surface of the panel 202e, and two liquid spray nozzles 300 positioned to spray cleaning liquid on to the lower surface of the panel 202e. The cleaning liquid thus sprayed is shown to be collected (318) by the wash section.

The air spray section 314 is shown to include, for example, an air spray head 302 positioned to spray air to blow the remaining cleaning liquid off of the upper surface of the panel 202d. Cleaning liquid resulting from such an operation is shown to be part of the collected liquid 318.

As shown in the example, the liquid spray section 310 and the air spray section 314 can be separated by a partition 312 to prevent interference of each other's operation, but allowing collection of the liquids from both sections. Other numbers and arrangements of liquid spray nozzles 300 and air spray heads 302 can also be implemented in the wash section.

The rinse section of the cleaning system 200 is shown to include a first rinse spray section 320 and a second rinse spray section 324. The first rinse spray section 320 is shown to include, for example, two liquid spray nozzles 300 positioned to spray rinsing liquid (e.g., water) on to the upper surface of the panel 202c, and two liquid spray nozzles 300 positioned to spray rinsing liquid (e.g., water) on to the lower surface of the panel 202c.

The second rinse spray section 324 is shown to include, for example, one liquid spray nozzle 300 positioned to spray rinsing liquid (e.g., water) on to the upper surface of the panel 202c, and one liquid spray nozzle 300 positioned to spray rinsing liquid (e.g., water) on to the lower surface of the panel 202c. The rinsing liquid thus sprayed in the first and second rinse spray sections 320, 324 is shown to be collected (328) by the rinse section.

In some embodiments, the rinsing water in the second rinse section 324 can be heated to a temperature higher than the temperature of the first rinse section 320. Use of such heated water can facilitate faster drying of the rinsed panels.

As shown in the example, the first rinse spray section 320 and the second rinse spray section 324 can be separated by a partition 322 to prevent, for example, contamination of the second rinsing process from the first rinse spray section 320, but allowing collection of the liquids from both sections. Other numbers and arrangements of liquid spray nozzles 300 can also be implemented in the rinse section. In the example shown, the wash section and the rinse section are shown to be separated by a partition 316 to prevent mixing of the cleaning liquid and the rinsing liquid.

The dry section of the cleaning system 200 is shown to include a first dry section 330 and a second dry section 334. In the example shown, the second dry section 334 can be optional. The first dry section 330 is shown to include, for example, air spray heads 302 positioned to blow drying air on to the upper surface of the panel 202b, and one air spray nozzle 302 positioned to blow drying air on to the lower surface of the panel 202b.

The second dry section 334 is shown to include, for example, air spray heads 302 positioned to blow drying air on to the upper surface of the panel 202a, and one air spray nozzle 302 positioned to blow drying air on to the lower surface of the panel 202a. The rinsing liquid blown off in the first and second dry sections 330, 334 is shown to be collected (328) in the rinse section by an angled surface 336.

As shown in the example, the first dry section 330 and the second dry section 334 can be separated by a partition 332 to successive drying operations, and to allow collection of the blown-off rinsing liquid from both sections. Other numbers and arrangements of air spray heads 300 can also be implemented in the dry section. In the example shown, the rinse section and the dry section are shown to be separated by a partition 326 to prevent interference of functions provided by the respective sections.

In some embodiments, air used in the first and second dry sections 330, 334 can be configured differently to promote more efficient drying. For example, air used in the second dry section 334 can be heated to have a higher temperature than the air used in the first dry section 330. Use of such heated air can facilitate faster final drying of the panels.

The dried panel 202a is shown to be exiting the cleaning system 200. As described herein, such a cleaned panel can be removed manually, automatically (e.g., into an unloading magazine), provided to a spray-paint system arranged in an in-line configuration, or some combination thereof. Similarly, panels provided to the cleaning system 200 can be input manually, automatically (e.g., from a loading magazine), from an ablation system arranged in an in-line configuration, or some combination thereof.

In some embodiments, at least some of the foregoing features associated with the cleaning system can be controlled by a controller having a processor. In some embodiments, such a controller can be configured to be in communication with a computer-readable medium (CRM) for storing, for example, various computer-executable instructions for performing and/or inducing various functionalities associated with the controller. In some implementations, such computer-executable instructions can be stored in a non-transitory manner.

In some embodiments, one or more features as described herein can be implemented during manufacture of packaged electronic modules, including radio-frequency (RF) modules such as a power amplifier (PA) module, a low noise amplifier (LNA) module, a switching module, a front-end module, a global positioning system (GPS) module, a controller module, an application processor module, an audio module, a display interface module, a memory module, a digital baseband processor module, an accelerometer module, a power management module, a transceiver module, or a module configured to provide one or more functionalities associated with such modules.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation (s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A device for transporting a panel having electronic modules formed thereon during a cleaning process, the device comprising a mesh configured to engage a surface of the panel during the cleaning process, the mesh having a coating configured to reduce the likelihood of damage to the surface of the panel and to provide desired electrostatic discharge protection for the panel.

2. The device of claim 1 wherein the coating of the mesh is configured to provide a desired mechanical property and a desired electrical conductivity.

3. The device of claim 2 wherein the mechanical property of the coating of the mesh includes either or both of smoothness and softness.

4. The device of claim 2 wherein the coated mesh has an edge-to-edge resistance R that is within a range of 1×10⁴≦R≦1×10¹¹ ohms when measured on the coating.

5. The device of claim 2 wherein the coated mesh has a resistivity value associated with a conductive electrostatic discharge protective device.

6. The device of claim 2 wherein the coated mesh has a resistivity value associated with a dissipative electrostatic discharge protective device.

7. The device of claim 2 wherein the coating includes fluoropolymer with small conductive particles mixed in.

8. The device of claim 2 wherein the surface of the panel includes an ablated surface of the panel, the ablated surface having exposed wires of shielding wirebonds, such that the desired mechanical property of the coating reduces or eliminates the likelihood of damage to the exposed wires.

9. A system for cleaning a panel having electronic modules formed thereon, the system comprising:
a first belt transport apparatus configured to support a first surface of the panel and move the panel during a cleaning process; and
a second belt transport apparatus configured to engage a second surface of the panel to keep the panel on the first belt transport apparatus during the cleaning process, the second belt transport apparatus including a mesh, the mesh having a coating configured to reduce the likelihood of damage to the second surface of the panel and to provide desired electrostatic discharge protection for the panel.

10. The system of claim 9 wherein the first belt transport apparatus includes an uncoated metal mesh.

11. The system of claim 9 wherein the coating of the mesh of the second belt transport apparatus includes fluoropolymer with small conductive particles mixed in.

12. The system of claim 9 wherein the second surface of the panel includes an ablated surface of the panel, the ablated surface having exposed wires of shielding wirebonds, such that the coating of the mesh reduces or eliminates the likelihood of damage to the exposed wires.

13. The system of claim 9 wherein the panel is oriented so that the first surface faces downwards and the second surface faces upwards.

14. The system of claim 13 further comprising a wash section, a rinse section, and a dry section.

15. The system of claim 14 wherein each of the first belt transport apparatus and the second belt transport apparatus extends through the wash section, the rinse section, and the dry section.

16. The system of claim 14 wherein each of the wash section and the rinse section includes a first spray nozzle configured to spray liquid downward onto the second surface of the panel, and a second spray nozzle configured to spray liquid upward onto the first surface of the panel.

17. The system of claim 16 wherein each of the wash section and the rinse section further includes a collection volume configured to collect the liquid that runs off of the panel.

18. The system of claim 14 wherein the dry section includes a first air spray head configured to spray air downward onto the second surface of the panel, and a second air spray head configured to spray air upward onto the first surface of the panel.

19. The system of claim 18 wherein the dry section further includes an angled surface configured to direct liquid collected during the drying process into the rinse section.

20. A method for cleaning a panel having electronic modules formed thereon, the method comprising:
moving the panel constrained between a first belt transport apparatus and a second belt transport apparatus, the first belt transport apparatus configured to support a first surface of the panel, the second belt transport apparatus configured to engage a second surface of the panel, the second belt transport apparatus including a mesh, the mesh having a coating configured to reduce the likelihood of damage to the second surface of the panel and to provide desired electrostatic discharge protection for the panel; and
applying cleaning fluid onto the first surface and the second surface of the panel, the mesh of the second belt transport apparatus configured to engage the second surface of the panel to thereby keep the panel on the first belt transport apparatus during the application of the cleaning fluid.
